(19) United States
(12) Patent Application Publication
(10) Pub. No.: US 2026/0323528 A1
(43) Pub. Date: Oct. 15, 2026

(54) USER EQUIPMENT COORDINATION SET (UECS) POWER CONTROL

(71) Applicant: Google LLC, Mountain View, CA (US)

(72) Inventors: Jibing Wang, San Jose, CA (US); Erik Stauffer, Sunnyvale, CA (US)

(21) Appl. No.: 19/485,026

(22) PCT Filed: May 2, 2024
(86) PCT No.: PCT/US2024/027495

§ 371 Date: Nov. 17, 2025

Related U.S. Application Data
(60) Provisional application No. 63/506,264, filed on Jun. 5, 2023.

(51) Int. Cl. H04W 52/14; H04W 52/24; H04W 52/28; H04W 52/36

(52) U.S. Cl. CPC H04W 52/146; H04W 52/245; H04W 52/285; H04W 52/365

(57) ABSTRACT

This disclosure provides systems, methods, and apparatuses for managing communications and controlling power in a subset (119) of a user equipment coordination set (UECS) (117) in a wireless communication system. According to aspects of the disclosure, a coordinating user equipment (UE) (110A) of the UECS selects (506, 606, 904) a subset (119) of the UEs of the UECS for joint transmission or joint reception of signals to or from the network entity, respectively. The coordinating UE determines the subset of the UEs of the UECS based on various UE conditions, such as reference signal received power (RSRP), specific absorption rate (SAR), battery condition, thermal condition, location of the UE, UE power class, or other factors. The coordinating UE allocates power and sends (604A, 604B, 604C) power control commands to the individual UEs in the subset of UEs in the UECS.

### RELATED APPLICATION

This application claims the priority benefit of U.S. Provisional Patent Application Ser. No. 63/506,264, filed Jun. 5, 2023, and entitled “USER EQUIPMENT COORDINATION SET (UECS) POWER CONTROL,” the entire contents of which is hereby incorporated by reference herein.

### TECHNICAL FIELD

Aspects of the present disclosure relate generally to wireless communication and techniques for controlling power in a user equipment coordination set in a wireless communication system.

### DESCRIPTION OF THE RELATED TECHNOLOGY

Generally, a provider of a wireless network manages wireless communications over the wireless network. For example, a base station manages a wireless connection with a user equipment (UE) that is connected to the wireless network. The base station determines configurations for the wireless connection, such as bandwidth, timing, protocol, and power levels for the wireless connection. The base station then transmits control messages to the UE to instruct the UE of the configurations for the wireless connection. The quality of service between a UE and a base station may be degraded by a number of factors, such as loss in signal strength, bandwidth limitations, interfering signals, and so forth. This is particularly true for UEs operating at a cell edge, which is frequently troubled by weak signal quality. One solution to address service degradation is to utilize a user equipment coordination set (UECS) for communication between a UE in the UECS and the base station. A UECS is a set of UEs that act together to jointly transmit or receive communications from the base station. The use of the multiple UEs in the UECS may improve service quality by compensating for low signal strength, compensating for interfering signals, increasing bandwidth and/or so forth.

Sufficient power must be used during signal transmission to ensure that an adequate signal quality is achieved between the base station and a UE. However, applying too much power during transmission by the UE may result in signal interference with other UEs communicating with the base station and may lead to excessive battery use by the UE, thereby leading to user dissatisfaction. Power control refers to one or more techniques to control the amount of power for signal transmission. A base station typically allocates power for uplink (UL) transmissions from the UECS for the UECS as a whole.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a coordinating user equipment (UE) of a user equipment coordination set (UECS). The method includes receiving, from one or more UEs of the UECS, an indicator corresponding to each of the one or more UEs, the indicator indicating a UE condition associated with at least one of a signal transmission to a network entity or a signal reception from the network entity. The method includes selecting a subset of the one or more UEs for inclusion in a UECS subset based on the UE condition of each corresponding UE of the UECS. The method includes managing a joint communication with the network entity via the UECS subset.

Another innovative aspect of the subject matter described in this disclosure can be implemented in a method for selecting UEs of a UECS for inclusion in multiple UECS subsets. The method includes selecting a first subset of the one or more UEs of the UECS for inclusion in a first UECS subset and a second subset of the one or more UEs of the UECS for inclusion in a second UECS subset. The method includes transmitting to the network entity information that indicates the first UECS subset and the second UECS subset. The method includes receiving, from the network entity, a first power control command for the first UECS subset and a second power control command for the second UECS subset. The method includes transmitting a third power control command to each UE of the first UECS subset based on the first power control command; and transmitting a fourth power control command to each UE of the second UECS subset based on the second power control command.

Aspects of the subject matter described in this disclosure can be implemented in a UE. The UE includes a communication unit and a processing system. The processing system is configured to control the communication unit to implement any one of the above-referenced methods.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a block diagram illustrating an example wireless system including a user equipment (UE) coordination set (UECS).

FIG. 2 is a block diagram illustrating example configurations of a base station and a user equipment.

FIG. 3 is a block diagram illustrating an example network stack.

FIG. 4A is a conceptual diagram illustrating a subset of a UECS.

FIG. 4B is a conceptual diagram illustrating multiple subsets of a UECS.

FIG. 5 is a sequence diagram illustrating operations for joint reception by a joint reception subset of a UECS.

FIG. 6 is a sequence diagram illustrating operations for joint transmission by a joint transmission subset of a UECS.

FIG. 7 is a sequence diagram illustrating operations for power control of a joint transmission subset of a UECS.

FIG. 8 is a sequence diagram illustrating operations for utilizing multiple subsets of a UECS.

FIG. 9 is a flow chart diagram illustrating operations of a method for managing joint communication by a coordinating UE of a UECS.

FIG. 10 is a flow chart diagram illustrating operations of a method for power control of multiple subsets of UEs of a UECS.

### DETAILED DESCRIPTION

The following description is directed to certain implementations for the purpose of describing the innovative aspects of this disclosure. However, a person having ordinary skill in the art will readily recognize that the teachings herein may be applied in a multitude of different ways. Some of the examples in this disclosure are based on wireless communication according to the 3^{rd} Generation Partnership Project (3GPP) wireless standards, such as the fourth generation (4G) Long Term Evolution (LTE) and 5^{th} generation (5G) new radio (NR) standards. However, the described implementations can be implemented in any device, system, or network that is capable of transmitting and receiving radio frequency signals according to any of the wireless communication standards, including any of the Institute of Electrical and Electronics Engineers (IEEE) 802.11, 802.15, or 802.16 wireless standards, or other known signals that are used to communicate within a wireless, cellular, or internet of things (IoT) network, such as a system utilizing 3G, 4G, 5G, 6^{th} generation (6G), Wi-Fi or future radio technology.

As discussed above, a base station may create a user equipment coordination set (UECS) to attempt to address service degradation for communication between a user equipment (UE) in the UECS and the base station. A UECS is a set of UEs that act together to jointly transmit or receive communications to or from the base station, respectively. The use of the multiple UEs in the UECS may improve service quality by compensating for low signal strength, compensating for interfering signals, increasing bandwidth and/or so forth.

Power control in a UE may be a delicate balance between applying enough power to communicate effectively with the base station without applying too much power such that the UE interferes with other UEs attempting to communicate with the base station. Applying more power than necessary may also result in overuse of the UE's battery, resulting in less operating time. Power control refers to one or more techniques to control the amount of power for signal transmission. As noted above, a base station typically allocates power for uplink (UL) transmissions from the UECS as a whole and does not necessarily allocate power for each of the various UEs in the UECS. However, a technical problem with allocating power for the UECS as a whole without taking individual conditions of each UE of a UECS into account is that a UE in the UECS may be instructed to transmit at a power level that is too high or too low for the current operating conditions and environment of the UE.

As a technical solution to the problems above, and according to aspects of the disclosure, a coordinating UE of the UECS may select a subset of the UEs of the UECS for joint transmission or joint reception of signals to or from the base station, respectively. The coordinating UE may determine the subset of the UEs of the UECS based on various UE conditions, such as reference signal received power (RSRP), specific absorption rate (SAR), battery condition, thermal condition, location of the UE, or other factors. The coordinating UE may allocate power and send power control commands to the individual UEs in the subset of UEs in the UECS. Thus, a technical advantage of the techniques disclosed herein over legacy systems is that UEs in a UECS subset may communicate with a base station at power levels that are tailored to the UE, resulting in a better balance between communications quality and battery life, and in less interference with other UEs communicating with the base station. The techniques described herein may be implemented in various practical applications as systems, methods, and apparatuses that provide for the creation, utilization, and power management of subsets of a UECS by a coordinating UE of the UECS.

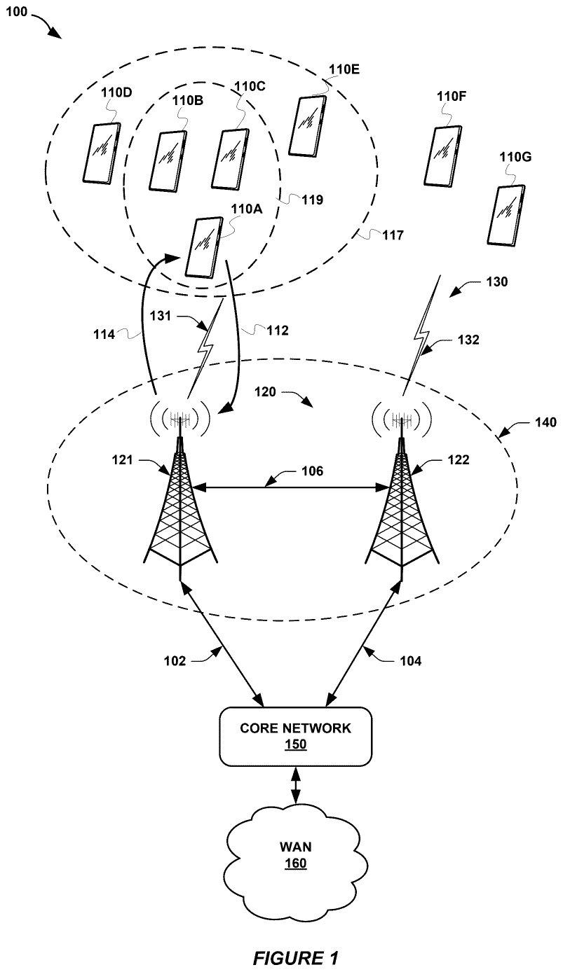

FIG. 1 is a block diagram illustrating an example wireless system 100 including a UECS 117. Wireless system 100 includes multiple UEs, including UEs 110A-110G (generically referred to as “UE 110”). Each UE 110 may communicate with one or more base stations 120 (illustrated as base stations 121 and 122) through one or more wireless communication links 130 (wireless link 130), illustrated as wireless links 131 and 132. In the example shown in FIG. 1, UEs 110A-110E have been selected by base station 120 for inclusion in UECS 117, while UEs 110F and 110G are not selected for inclusion in the UECS 117. Although illustrated as a smartphone in FIG. 1, the UE 110 may be implemented as any suitable computing or electronic device, such as a mobile communication device, a modem, cellular phone, gaming device, navigation device, media device, laptop computer, desktop computer, tablet computer, smart appliance, vehicle-based communication system, an IoT device (e.g., sensor node, controller/actuator node, combination thereof), and the like. The base stations 120 (e.g., network entity, an evolved universal terrestrial radio access network node B, E-UTRAN Node B, evolved node B, eNodeB, eNB, next generation Node B, gNode B, gNB, ng-eNB, or the like) may be implemented in a macrocell, microcell, small cell, picocell, or the like, or any combination thereof.

The base stations 120 communicate with the UE 110 using the wireless links 131 and 132, which may be implemented as any suitable type of wireless link. The wireless links 131 and 132 include control and data communication, such as downlink of data and control information communicated from the base stations 120 to the UE 110, uplink of other data and control information communicated from the UE 110 to the base stations 120, or both. The wireless links 130 may include one or more wireless links (e.g., radio links) or bearers implemented using any suitable communication protocol or standard, or combination of communication protocols or standards, such as 3GPP LTE, 5G NR, and so forth. Multiple wireless links 130 may be aggregated in a carrier aggregation to provide a higher data rate for the UE 110. Multiple wireless links 130 from multiple base stations 120 may be configured for coordinated multipoint (COMP) communication with the UE 110.

Each base station 120 supports wireless communication with one or more UEs, such as UE 110, via radio frequency (RF) signaling using one or more applicable radio access technologies (RATs) as specified by one or more communications protocols or standards. Base stations 120 may employ any of a variety of RATs, such as operating as a NodeB (or base transceiver station (BTS)) for a universal mobile telecommunications system (UMTS) RAT (also known as “3G”), operating as an enhanced NodeB (“eNB”) for a 3GPP LTE RAT, operating as a 5G node B (“gNB”) for a 3GPP 5G NR RAT, and the like.

The base stations 120 are collectively a radio access network (RAN) 140 (e.g., E-UTRAN, 5G NR RAN, or NR RAN). The base stations 121 and 122 in the RAN 140 are connected to a core network 150. The base stations 121 and 122 connect, at 102 and 104, respectively, to the core network 150 through an NG2 interface for control-plane signaling and using an NG3 interface for user-plane data communications when connecting to a 5G core network, or using an Si interface for control-plane signaling and user-plane data communications when connecting to an Evolved Packet Core (EPC) network. The base stations 121 and 122 may communicate using an Xn Application Protocol (XnAP) through an Xn interface or using an X2 Application Protocol (X2AP) through an X2 interface, at 106, to exchange user-plane and control-plane data. The UE 110 may connect, via the core network 150, to one or more wide area networks (WANs) 160 or other packet data networks (PDNs), such as the Internet.

Communications between base station 120 and UE 110 utilize an uplink (UL) transmission path 112 for radio frequency RF transmissions from the UE 110 to the base station 120 and a downlink (DL) transmission path 114 for RF transmissions from the base station 120 to the UE 110. As such, in the context of the UL transmission path 112, the UE 110 serves as the data sending device and the base station 120 serves as the data receiving device, whereas in the context of the DL transmission path 114, the base station 120 serves as the data sending device and the UE 110 serves as the data receiving device. UL transmission path 112 and DL transmission path 114 may utilize multiple communications channels for signal transmission. The multiple channels may each have different purposes.

UL transmission path 112 may include one or more of a physical uplink shared channel (PUSCH), a physical uplink control channel (PUCCH), and a physical random access channel (PRACH). The PUSCH is used for the transmission of user data, such as voice data, video data, or text message data from UE 110 to base station 120. Additionally, the PUSCH may be used to transmit control information (e.g., uplink control information (UCI)). The PUSCH may be shared by multiple UEs. The PUCCH is used for transmitting control information (e.g., UCI) from the UE 110 to the network, such as channel quality feedback, scheduling requests, and acknowledgments. The PRACH is used for random access in the uplink direction, enabling the UE 110 to establish access to the system.

DL transmission path 114 may include one or more of a physical downlink shared channel (PDSCH), a physical downlink control channel (PDCCH), a physical broadcast channel (PBCH), or a paging channel. The PDSCH is used for transmission of user data from the base station 120 to the UE 110. The PDSCH may be shared by multiple UEs. As with the PUSCH, the data may be any type of information, such as voice data, video data, or text message data. The paging channel is used to notify UE 110 that there is incoming traffic for it from base station 120.

During operation, the base station 120 may select UEs 110 for inclusion in a UECS 117. The base station 120 may also select a UE (e.g., UE 110A) of the UECS to be a coordinating UE. A UE in the UECS 117 that has data to be transmitted to the base station 120 may be referred to as a source UE. A UE in the UECS 117 that is to receive data from the base station 120 may be referred to as a target UE. The UEs 110 in UECS 117 (for example, UEs 110A-110E) may communicate with one another and the selected coordinating UE of the UECS, a source UE, and/or a target UE in the UECS 117 through one or more local wireless network connections (not shown in FIG. 1). Examples of such local wireless network connections include wireless local-area network (WLAN), Bluetooth, near field communication (NFC), a personal area network (PAN), WiFi-Direct, IEEE 802.15.4, ZigBee, Thread, millimeter wavelength communication (mmWave), and the like. In some aspects, the UEs 110 in the UECS 117 may communicate with one another and the coordinating UE, a source UE and/or a target UE via a sidelink channel of the RAN 140.

The coordinating UE 110A of the UECS 117 may select one or more UEs (e.g., UE 110A-110C) of UECS 117 to be included in a UECS subset 119. For example, the UEs in the UECS 117 may transmit indicators representing one or more conditions of the respective UEs to the coordinating UE 110A. The coordinating UE 110A may select UEs for inclusion in the UECS subset 119 based on the UE condition. For example, the UEs of the UECS 117 may send, to the coordinating UE 110A, their respective RSRP values. The coordinating UE 110A may use the RSRP values for determining which UEs of the UECS 117 to include in the UECS subset 119. Other UE conditions associated with transmission, reception, and/or operation of a UE may be used instead of, or in addition, RSRP to select UEs for inclusion in the UECS subset 119. For example, SAR, battery condition, thermal condition, power headroom, and location, among others, may be used by the coordinating UE 110A to select UEs for inclusion in the UECS subset 119. Here, the coordinating UE 110A selects, itself, UE 110B, and 110C to be included in the UECS subset 119.

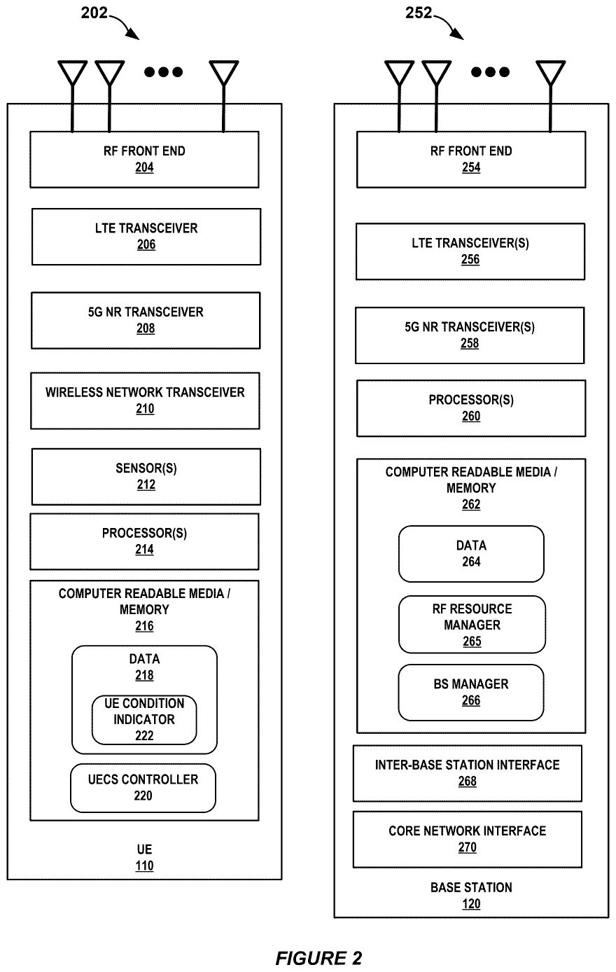

FIG. 2 is a block diagram illustrating example configurations of a base station 120 and a UE 110. Note that the depicted hardware configurations represent the processing components and communication components related to formation and usage of a UECS and one or more subsets of a UECS described herein and omit certain components well-understood to be frequently implemented in such electronic devices, such as displays, peripherals, power supplies, and the like.

The UE 110 includes antennas 202, a radio frequency front end (RF front end) 204, and radio-frequency transceivers (e.g., an LTE transceiver 206 and a 5G NR transceiver 208) for communicating with base stations 120 in the RAN 140 (FIG. 1). The UE 110 includes one or more additional transceivers (e.g., local wireless network transceiver 210) for communicating over one or more wireless local wireless networks (e.g., WLAN, Bluetooth, NFC, a PAN, WiFi-Direct, IEEE 802.15.4, ZigBee, Thread, mmWave, or the like) with at least the coordinating UE, a source UE, and/or a target UE, of the UECS.

The RF front end 204 includes one or more modems configured for the corresponding RAT(s) employed (for example, 3GPP 5G NR), one or more analog-to-digital converters (ADCs), one or more digital-to-analog converters (DACs), signal processors, and the like. In the example illustrated in FIG. 2, the RF front end 204 of the UE 110 can couple or connect the LTE transceiver 206, the 5G NR transceiver 208, and the local wireless network transceiver 210 to the antennas 202 to facilitate various types of wireless communication. The RF front end 204 operates, in effect, as a physical (PHY) transceiver interface to conduct and process signaling between the one or more processors 214 and the antennas 202 so as to facilitate various types of wireless communication.

The antennas 202 of the UE 110 may include an array of multiple antennas that are configured similar to or different from each other and may be tuned to one or more frequency bands associated with a corresponding RAT. The antennas 202 and the RF front end 204 may be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to support beamforming for the transmission and reception of communications with the base stations 120. By way of example and not limitation, the antennas 202 and the RF front end 204 may be implemented for operation in sub-gigahertz bands, sub-6 GHz bands, and/or above 6 GHz bands that are defined by the 3GPP LTE and 5G NR communication standards. In addition, the RF front end 204 may be tuned to, and/or be tunable to, one or more frequency bands defined and implemented by the local wireless network transceiver 210 to support transmission and reception of communications with other UEs in the UECS over a local wireless network.

The UE 110 includes sensor(s) 212 that may be implemented to detect various properties such as temperature, supplied power, power usage, battery state, or the like. As such, the sensors 212 may include any one or a combination of temperature sensors, thermistors, battery sensors, and power usage sensors.

The UE 110 also includes processor(s) 214 and computer-readable storage media (CRM) 216. The processor 214 may include, for example, one or more central processing units (CPUs), graphics processing units (GPUs), or other application-specific integrated circuits (ASIC), and the like. To illustrate, the processors 214 may include an application processor (AP) utilized by the UE 110 to execute an operating system and various user-level software applications, as well as one or more processors utilized by modems or a baseband processor of the RF front end 204.

CRM 216 may include any suitable memory or storage device such as random-access memory (RAM), static RAM (SRAM), dynamic RAM (DRAM), non-volatile RAM (NVRAM), read-only memory (ROM), Flash memory, solid-state drive (SSD) or other mass-storage devices, and the like useable to store one or more sets of executable software instructions and associated data that manipulate the one or more processors 214 and other components of the UE 110 to perform the various functions described herein and attributed to the UE 110. The sets of executable software instructions include, for example, an operating system (OS) and various drivers (not shown), and various software applications (not shown), which are executable by processor(s) 214 to enable user-plane communication, control-plane signaling, and user interaction with the UE 110. The data 218 stored in the CRM 216 represents, for example, user data, multimedia data, beamforming codebooks, software application configuration information, UECS and UECS subset configuration information and the like. Data 218 may store UE condition indicator 222. UE condition indicator 222 may be data representing one or more conditions on the UE 110. Examples of such conditions include RSRP, battery status, battery condition, thermal conditions, SAR, among others.

CRM 216 also includes a UECS controller 220. Alternately or additionally, the UECS controller 220 may be implemented in whole or part as hardware logic or circuitry integrated with or separate from other components of the UE 110. In at least some UECSs, the UECS controller 220 configures the RF front end 204, the LTE transceiver 206, the 5G NR transceiver 208, and/or the local wireless network transceiver 210 to implement the techniques described herein for creating and maintaining a UECS and UECS subsets.

Turning to the hardware configuration of the base station 120, it is noted that although FIG. 2 illustrates an implementation of the base station 120 as a single network node (for example, a 5G NR Node B, or “gNB”), the functionality, and thus the hardware components, of the base station 120 instead may be distributed across multiple network nodes or devices and may be distributed in a manner to perform the functions described herein. As one example, the functionality of base station 120 may be distributed across a radio unit (RU), distributed unit (DU), or central unit (CU).

The base stations 120 include antennas 252, a radio frequency front end (RF front end) 254, one or more LTE transceivers 256, and/or one or more 5G NR transceivers 258 for communicating with the UE 110. The RF front end 254 of the base stations 120 may couple or connect the LTE transceivers 256 and the 5G NR transceivers 258 to the antennas 252 to facilitate various types of wireless communication. Similar to RF front end 204, the RF front end 254 includes one or more modems, one or more ADCs, one or more DACs, and the like. RF front end 254 receives the one or more RF signals, for example, RF signals from UE 110, and pre-processes the one or more RF signals to generate data from the RF signals that is provided as input to processes and/or applications executing on base station 120. This pre-processing may include, for example, power amplification, conversion of band-pass signaling to baseband signaling, initial analog-to-digital conversion, and the like.

The antennas 252 of the base stations 120 may be configured individually and/or as one or more arrays of multiple antennas. The antennas 252 and the RF front end 254 may be tuned to, and/or be tunable to, one or more frequency band defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as massive multiple-input and multiple-output (Massive-MIMO), for the transmission and reception of communications with any UE 110 in a UECS.

The base stations 120 also include processor(s) 260 and computer-readable storage media (CRM) 262. The processor 260 may include, for example, one or more central processing units (CPUs), graphics processing units (GPUs), or other application-specific integrated circuits (ASIC), and the like. To illustrate, the processors 260 may include an application processor (AP) utilized by the base station 120 to execute an operating system and various user-level software applications, as well as one or more processors utilized by modems or a baseband processor of the RF front end 254 to enable communication with the UE 110.

CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data of the base stations 120. The device data may include data 264, which includes network scheduling data, radio resource management data, beamforming codebooks, software application configuration information, UE transmitter power levels, and/or UECS configuration data and the like.

CRM 262 also includes an RF resource manager 265. In some aspects, the RF resource manager 265 of the base station 120 is implemented to perform various functions associated with allocating physical access (for example, resource blocks) or communication resources for the air interface of the base station 120. The air interface of the base station 120, may be partitioned or divided into various units (for example, frames, subframes, or slots) of one or more of bandwidth, time, symbols, or spatial layers. For example, within a framework of a 5G NR protocol, the RF resource manager 265 may allocate bandwidth and time intervals of access in resource blocks, each of which may be allocated in whole, or in part, to one or more channels for communicating with the UE 110. The channels may include one or more of a PRACH, a PUCCH, a PUSCH, a PDCCH, a PDSCH, a PBCH, or a paging channel. The resource blocks may include multiple subcarriers that each span a portion of a frequency domain of the resource blocks. The subcarriers may be further divided into resource elements, or orthogonal frequency-division multiplexing (OFDM) symbols, that each span a portion of a time domain of the subcarriers. Consequently, a resource block includes multiple OFDM symbols that may be grouped into subcarriers with other OFDM symbols having a common frequency bandwidth.

CRM 262 further includes a base station manager 266. Alternately or additionally, the base station manager 266 may be implemented in whole or part as hardware logic or circuitry integrated with or separate from other components of the base stations 120. In at least some aspects, the base station manager 266 configures the LTE transceivers 256 and the 5G NR transceivers 258 for communication with the UE 110, as well as communication with a core network 150 (FIG. 1).

In some aspects, the base stations 120 includes an inter-base station interface 268, such as an Xn and/or X2 interface, which the base station manager 266 configures to exchange user-plane and control-plane data between another base station 120, to manage the communication of the base stations 120 with the UE 110. The base stations 120 include a core network interface 270 that the base station manager 266 configures to exchange user-plane and control-plane data with core network functions and entities.

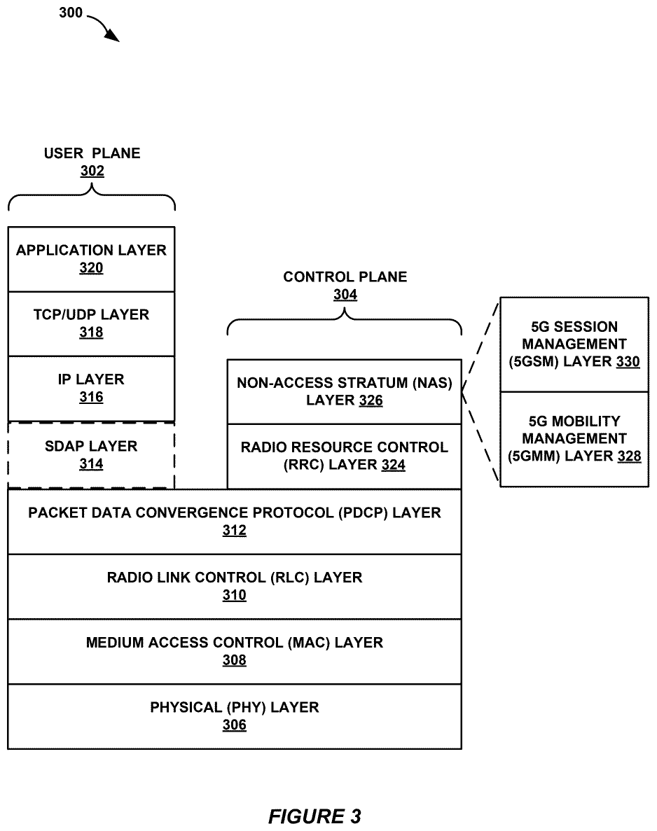

FIG. 3 is a block diagram illustrating an example wireless network stack (“stack 300”). The stack 300 characterizes a communication system for the example wireless system 100 in which various aspects of UECS management and power control can be implemented. The stack 300 includes a user plane 302 and a control plane 304. The upper layers of the user plane 302 and the control plane 304 share common lower layers in the stack 300. Wireless devices, such as the UE 110 or the base station 120, implement each layer as an entity for communication with another device using the protocols defined for the layer. For example, a UE 110 may use a packet data convergence protocol (PDCP) entity to communicate to a peer PDCP entity in a base station 120 using the PDCP.

The shared lower layers include a physical (PHY) layer 306, a medium access control (MAC) layer 308, a radio link control (RLC) layer 310, and a PDCP layer 312. The PHY layer 306 provides hardware specifications for devices that communicate with each other. As such, the PHY layer 306 establishes how devices connect to each other, assists in managing how communication resources are shared among devices, and the like.

The MAC layer 308 specifies how data is transferred between devices. Generally, the MAC layer 308 provides a way in which data packets being transmitted are encoded and decoded into bits as part of a transmission protocol.

The RLC layer 310 provides data transfer services to higher layers in the stack 300. Generally, the RLC layer 310 provides error correction, packet segmentation and reassembly, and management of data transfers in various modes, such as acknowledged, unacknowledged, or transparent modes.

The PDCP layer 312 provides data transfer services to higher layers in the stack 300. Generally, the PDCP layer 312 provides transfer of user plane 302 and control plane 304 data, header compression, ciphering, and integrity protection.

Above the PDCP layer 312, the stack splits into the user plane 302 and the control plane 304. Layers of the user plane 302 include an optional service data adaptation protocol (SDAP) layer 314, an Internet Protocol (IP) layer 316, a Transmission Control Protocol/User Datagram Protocol (TCP/UDP) layer 318, and an application layer 320, which transfers data using the wireless link 106 (FIG. 1). The optional SDAP layer 314 is present in 5G NR networks. The SDAP layer 314 maps a Quality of Service (QoS) flow for each data radio bearer and marks QoS flow identifiers in uplink and downlink data packets for each packet data session. The IP layer 316 specifies how the data from the application layer 320 is transferred to a destination node. The TCP/UDP layer 318 is used to verify that data packets intended to be transferred to the destination node reached the destination node, using either TCP or UDP for data transfers by the application layer 320. In some implementations, the user plane 302 may also include a data services layer (not shown) that provides data transport services to transport application data, such as IP packets including web browsing content, video content, image content, audio content, or social media content.

The control plane 304 includes a radio resource control (RRC) layer 324 and a non-access stratum (NAS) layer 326. The RRC layer 324 establishes and releases connections and radio bearers, broadcasts system information, or performs power control. The RRC layer 324 also controls a resource control state of the UE 110 and causes the UE 110 to perform operations according to the resource control state. Example resource control states include a connected state (e.g., an RRC connected state) or a disconnected state, such as an inactive state (e.g., an RRC inactive state) or an idle state (e.g., an RRC idle state). In general, if the UE 110 is in the connected state, the connection with the base station 120 is active. In the inactive state, the connection with the base station 120 is suspended. If the UE 110 is in the idle state, the connection with the base station 120 is released. Generally, the RRC layer 324 supports 3GPP access but does not support non-3GPP access (e.g., WLAN communications).

The NAS layer 326 provides support for mobility management (e.g., using a Fifth-Generation Mobility Management (5GMM) layer 328) and packet data bearer contexts (e.g., using a Fifth-Generation Session Management (5GSM) layer 330) between the UE 110 and entities or functions in the core network, such as an Access and Mobility Management Function (AMF) of the 5G core network (5GC) 150 (FIG. 1) or the like. The NAS layer 326 supports both 3GPP access and non-3GPP access.

In the UE 110, each layer in both the user plane 302 and the control plane 304 of the stack 300 interacts with a corresponding peer layer or entity in the base station 120, a core network entity or function, and/or a remote service, to support user applications and control operation of the UE 110 in the RAN 140 (FIG. 1).

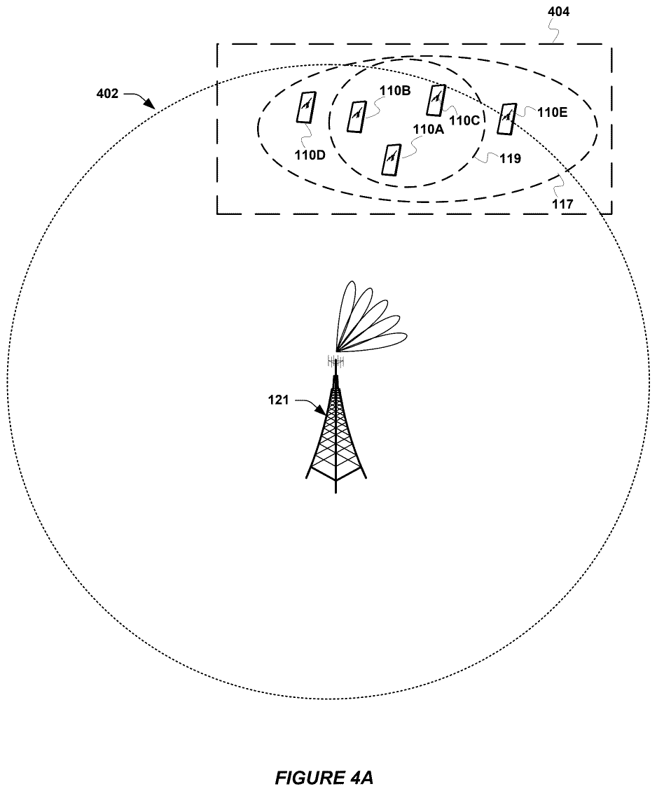

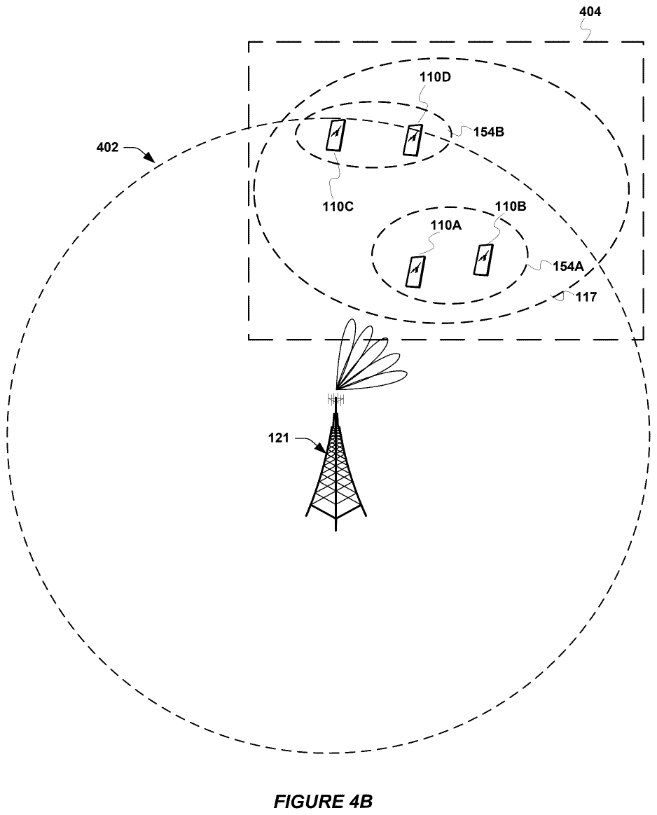

FIG. 4A is a conceptual diagram illustrating a subset of a UECS. The example illustrated in FIG. 4A includes a base station 121 and UEs 110A-110E configured as a UECS 117. Although, for the sake of illustration clarity, the UECS 117 in FIG. 4A is illustrated as including five UEs, any suitable number of UEs may be included in a UECS. In an example, each of the UEs illustrated in FIG. 4A has limited transmit power which may result in difficulty transmitting uplink data to the base station 121. This may be due, at least partially, to the UEs being proximate to a cell edge 402 of the cell provided by the base station 121, or the UEs being in a transmission-challenged location (e.g., a basement, urban canyon, etc.) resulting in a poor link budget between the base station 121 and the UEs. Each of the UEs illustrated in FIG. 4A may also, or alternatively, have limited receiver sensitivity, which may be affected by a poor link budget with the base station 121, as well as multipath reception, interference from in-band or out-of-band sources, attenuation from weather conditions or objects such as buildings, trees, etc.

The base station 121 may specify a set of UEs (e.g., the UEs 110A-110E) to form a UECS (e.g., the UECS 117) for joint transmission and/or joint reception of data for a source UE or a target UE (e.g., the UE 110B). The base station 121 may determine, based on information corresponding to the UEs (e.g., UE location, signal level, battery level, and so on), whether coordination is beneficial for a particular UE or not. Based on a user input or predefined setting, each of the UEs may opt in or out of participation in the UECS. An effective transmit power of the target UE 110B may increase significantly (e.g., linearly) with the number of UEs in the UECS 117, which may improve a link budget of the source or target UE (e.g., UE 110B). The base station 121 may determine a UECS based on various factors, such as a location of each UE relative to the base station 121, distance between the UEs (such as between each other, between each UE and a source UE, between each UE and a target UE, or between each UE and a coordinating UE of the UECS) or a combination thereof. In some aspects, UEs within a certain distance of each other can more easily coordinate with one another to reduce signal interference when in close proximity by using a local wireless network.

In addition, UE coordination can be based on spatial beams or timing advance, or both, associated with each UE. For example, for beamforming or Massive-MIMO, it may be desirable that all the UEs within the UECS are able to receive the same signal from the base station. Therefore, all the UEs within the UECS may be geographically near one another, e.g., within a threshold distance of a particular UE in the UECS. In this way, the UEs in the UECS may be served with the same beam or beams that are close to each other. Timing advance may indicate a distance between a UE and the base station. A similar timing advance for each UE in a group indicates that those UEs are approximately the same distance from the base station. UEs within a predefined distance of one another that are all a similar distance from the base station may be capable of working together in a UECS in a distributed fashion to improve a signal strength and quality to the benefit of a single UE in the UECS.

The base station may send messages (e.g., downlink control information (DCI), MAC, RRC) to UEs to direct or request those UEs to join the UECS. The base station may provide additional data to the UEs within the UECS to enable the UEs to communicate with at least the coordinating UE (e.g., UE 110A) or the target UE (e.g., UE 110B). The additional data may include an identity of the coordinating UE and/or an identity of the target UE, security information, and/or local wireless network information.

The base station may receive a response message from a UE in the UECS acknowledging the request message. In some cases, the base station may receive a response message from at least two of the UEs acknowledging that a UE has joined the UECS. The response message may indicate that the UE has approved the request message.

In addition, the base station may identify and command (or request) a specific UE within the UECS to act as a coordinating UE (e.g., master or primary UE) for the UECS. For example, the base station 121 may transmit a configuration message (e.g., request message) to the specific UE (in this example, UE 110A) to request that the specific UE act as the coordinating UE for the UECS. The specific UE may accept or decline the request based on user input from the UE or a setting that is set to automatically accept or decline such requests. In some aspects, the UE may transmit a UE-capability message or other RRC message as a response to the request message from the base station 121. The coordinating UE may coordinate the messages and samples sent between UEs within the UECS for joint transmission and/or joint reception. In aspects, the coordinating UE may determine where the joint processing is to occur, e.g., at the coordinating UE, a source UE, or a target UE. In an example, the coordinating UE may coordinate how a particular UE in the UECS is to send in-phase/quadrature-phase (I/Q) samples, which the particular UE demodulates from signals received from the base station to the target UE.

The base station may select the coordinating UE from the group of UEs in the UECS based on a variety of factors, some of which may be signaled to the base station by the UE using a UE-capability message. For example, one factor includes processing power of the coordinating UE, which provides the coordinating UE the capability to handle certain aspects of the UECS including central coordination or scheduling. Another factor may include a battery-level state of the coordinating UE. For instance, if a particular UE in the UECS has a low battery, then that UE may not be a good candidate to act as the coordinating UE. Accordingly, UEs within the UECS that have a battery-level state above a threshold value may be considered as candidates for selection as the coordinating UE. In one example, the base station may first select one UE as a coordinating UE, and receive, subsequent to formation of the UECS, messages from the other UEs in the UECS indicating respective battery-level states. Then, the base station may change the coordinating UE if another UE in the UECS would be a better candidate based on the battery-level states of the UEs in the UECS.

Yet another factor may include a location of the coordinating UE. The base station may identify the location of the UEs in the UECS based on various factors, such as angle of arrival of signals from the UE, timing advance, observed time difference of arrival (OTDOA), and so on. The base station may select a UE that is geographically central in the UECS to be the coordinating UE as this may maximize the coordinating UE's capability to coordinate and communicate with the other UEs in the UECS. However, the coordinating UE is not required to be in a central location of the UEs in the UECS. Rather, the coordinating UE can be located at any location within the UECS that allows the coordinating UE to communicate and coordinate with the other UEs in the UECS. The base station monitors the UECS and may update the coordinating UE at any time based on updated information, such as updated UE locations, UE battery-level state, and so on. Or, as mentioned previously, the coordinating UE may transfer its joint processing responsibilities to another UE based on factors such as processing power, battery level, and/or geographic location.

In some aspects, the base station may receive indications from one or more UEs in the UECS that advertise their capability to act as the coordinating UE. Additionally or alternatively, the base station may receive indications from one or more UEs in the UECS that indicate a willingness of a user of a respective UE to allow their UE to participate in the UECS and/or act as the coordinating UE. Accordingly, a UE in the UECS may indicate to the base station whether it is capable of acting and/or is permitted to act as the coordinating UE.

In the example illustrated in FIG. 4A, the base station 121 may select UE 110A to act as the coordinating UE because the UE 110A is located between UEs 110B-110E or because the UE 110A is capable of communicating with each of the other UEs 110B-110E in the UECS 117. The base station 121 may select the coordinating UE for various reasons, examples of which are described above. Being at the cell edge, all of the UEs 110A-110E may have weak cellular signal reception. The base station 121 selects UE 110A to coordinate messages and samples sent between the base station 121 and the UEs 110A-110E for a target UE (e.g., UE 110B). Communication among the UEs may be achieved using a local wireless network 404 that utilizes short-range radio frequencies for communication, such as a PAN, NFC, Bluetooth, WiFi-Direct, local mmWave link, etc. In this example, all the UEs 110A-110E receive RF signals from the base station 121. The UEs 110A-110E demodulate the RF signals to produce baseband I/Q analog signals and sample the baseband I/Q analog signals to produce I/Q samples. The UEs 110B-110E forward the I/Q samples along with system timing information (e.g., system frame number (0)) using the local wireless network 404 to the coordinating UE 110A. The coordinating UE 110A may use the timing information to synchronize and combine the I/Q samples and processes the combined signal to decode data packets for the target UE 110B. The coordinating UE 110A transmits the data packets to the target UE 110B using the local wireless network 404. In some other examples, the UEs 110B-110E may forward the I/Q samples to the coordinating UE 110A via a sidelink channel (of the RAN 140 of FIG. 1). Accordingly, the coordinating UE 110A may transmit the data packets to the target UE 110B via the sidelink channel.

When the UE 110B has uplink data to send to the base station 121, the UE 110B may be referred to as a source UE. In this case, the source UE transmits the uplink data to the coordinating UE 110A that uses the local wireless network 404 or the sidelink channel to distribute the uplink data, as I/Q samples, to each UE in the UECS 117. Each UE in the UECS 117 synchronizes with the base station 121 for timing information and its data transmission resource assignment. Then, the UEs in the UECS 117 jointly transmit the uplink data to the base station 121. The base station 121 receives the jointly transmitted uplink data from the UEs 110A-110E and processes the combined signal to decode the uplink data from the source UE 110B.

FIG. 4B is a conceptual diagram illustrating multiple subsets of a UECS. The example illustrated in FIG. 4B can use the same process for creating a UECS as described above with respect to FIG. 4A. However, instead of creating a single UECS subset, the coordinating UE 110A in the example of FIG. 4B creates multiple UECS subsets, referred to as virtual subsets. The example illustrated in FIG. 4B includes a base station 121 and UEs 110A-110D configured as a UECS 117. Although, for the sake of illustration clarity, the UECS 117 in FIG. 4B is illustrated as including four UEs, any suitable number of UEs may be included in a UECS 117.

The base station 121 may specify a set of UEs (e.g., the UEs 110A-110D) to form a UECS (e.g., the UECS 117) in the same manner as described above with respect to FIG. 4A. After formation of the UECS and designation of a UE as a coordinating UE (UE 110A in this example), the coordinating UE may select UEs within the UECS 117 for inclusion in multiple virtual subsets of UECS 117. In the example shown in FIG. 4B, coordinating UE 110A has created two virtual subsets, virtual subset 154A and 154B. Virtual subset 154A includes UEs 110A and 110B, and virtual subset 154B includes UEs 110C and 110D. A coordinating UE may select more than two virtual subsets and may include more than two UEs in a virtual subset. Further, each subset may have a different number of UEs included in the subset.

In some aspects, the coordinating UE 110A may receive location information regarding the UEs in the UECS 117 and use the location information to select UEs in the UECS 117 for inclusion in a virtual subset. Location information received from a UE may be based on global positioning system-reported (GPS-reported) position of the UE. Further, a GPS-equipped UE may locate and report the positions of other UEs. Additionally, or alternatively, the base station 121 may optionally transmit location information for one or more of the UEs in the UECS 117 to the coordinating UE 110A. The location information reported by the base station 121 may be based on observed time difference of arrival (OTDOA) data, angle of arrival (AOA) data, or angle of departure (AOD) data, among other information.

The coordinating UE 110A may use the location information of the UEs in the UECS 117 to create virtual subsets of UEs of the UECS by selecting UEs that are near each other for inclusion in the same virtual subset. In the example illustrated in FIG. 4B, coordinating UE 110A has created a first UECS virtual subset 154A that includes the coordinating UE 110A and nearby UE 110B. Additionally, the coordinating UE 110A has created a second UECS virtual subset 154B that includes UE 110C and UE 110D that are near each other.

The coordinating UE 110A may report the number of UECS virtual subsets to the base station 121. From the point of view of the base station 121, each UECS virtual subset 154A and 154B behaves like a transmit (TX) port of the coordinating UE 110A (or source UE or target UE). Thus, the coordinating UE 110A (or source UE or target UE) may use the virtual subsets as transmit ports in a multiple-input and multiple-output (MIMO) transmission to base station 121. For instance, in the example shown in FIG. 4B, virtual subsets 154A and 154B can be used in an uplink (UL) 2×2 MIMO joint transmission. That is, the virtual subset 154A may perform uplink transmission on one layer of the MIMO transmission, and the virtual subset 154B may perform uplink transmission on another layer of the MIMO transmission.

The base station 121 may provide power commands for the UECS virtual subsets 154A and 154B to the coordinating UE 110A. The coordinating UE 110A may forward the power commands to the appropriate UEs of the respective UECS virtual subsets 154A and 154B. For example, the coordinating UE 110A forwards the power control command received from the base station 121 for UECS virtual subset 154A to UE 110B to instruct UE 110B to adjust its transmission power for communications to base station 121. Additionally, because the coordinating UE 110A is in UECS virtual subset 154A, the coordinating UE 110A processes the power control command to adjust its power transmission levels when communicating with base station 121. The coordinating UE 110A forwards power control commands received from the base station 121 for UECS virtual subset 154B to the UEs 110C and 110D in the UECS virtual subset, to instruct the UEs to adjust their power levels for transmissions to the base station 121.

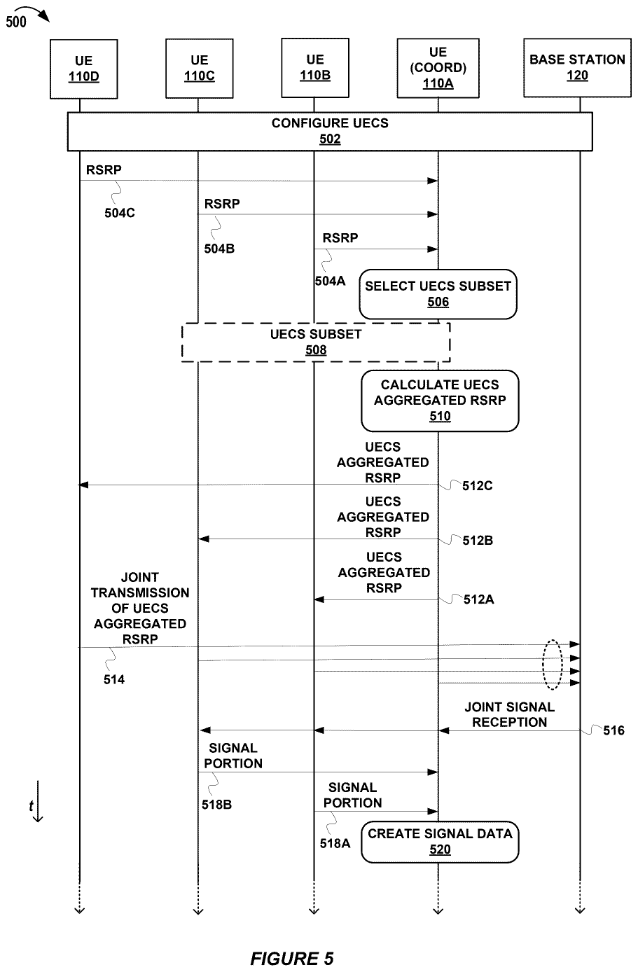

FIG. 5 is a sequence diagram 500 illustrating operations for joint reception by a joint reception subset of a UECS. Although not illustrated for the sake of illustration clarity, various acknowledgements for messages illustrated in FIG. 5 may be implemented to ensure reliable operations of UECS control aggregation.

At operation 502 and as described above with respect to FIGS. 4A and 4B, the base station 120 configures a UECS (e.g., the UECS 117) including the UEs 110A-110D. The base station 120 configures the UE 110A as the coordinating UE for the UECS. Although, for the sake of illustration clarity, the UECS in FIG. 5 is illustrated as including four UEs, any suitable number of UEs may be included in the UECS.

Each UE in the UECS reports their respective RSRP value to the coordinating UE. In the example, shown in FIG. 5, at operations 504A, 504B, and 504C, each UE in the UECS (e.g., UEs 110B, 110C, and 110D, respectively) report their respective UE's RSRP value to the coordinating UE 110A. In some aspects, each UE within the UECS reports their respective RSRP to the coordinating UE via a short-range communications link. In some aspects, the short-range communications link includes an out-of-band communications link (e.g., a communications link that is not part of the RAN 140 (FIG. 1), for example, wireless network 404 (FIGS. 4A and 4B)). As an example, the out-of-band communications link can be a Bluetooth, Wi-Fi, or other wireless communication link supported by the UEs in the UECS via a wireless transceiver (e.g., wireless network transceiver 210 (FIG. 2)). In some other aspects, the short range communications link includes a sidelink channel (which may be part of the RAN 140 in FIG. 1).

At operation 506, the coordinating UE 110A selects one or more of the UEs in the UECS for inclusion in a UECS subset 508. In some aspects, coordinating UE 110A may select UEs for inclusion in the UECS subset 508 based on the RSRP value reported by each UE in the UECS. For example, the coordinating UE 110A may select UEs for UECS subset 508 based on the UEs having RSRPs that exceed a predetermined or configurable threshold, or RSRPs that have relatively higher RSRPs. In some aspects, the UECS subset 508 is a proper subset (also referred to as a “strict” subset) of the UECS. That is, the UECS subset 508 is different from the UECS. In some aspects, the UECS subset 508 may be the same as the UECS.

Although operation 506 discusses the formation of a UECS subset based on RSRP, it is understood that other UE conditions may be used instead of, or in addition to, RSRP. For example, UE battery status or condition, UE thermal condition, or UE location may be reported to the coordinating UE 110A and used as a basis for inclusion in a UECS subset 508.

At operation 510, the coordinating UE 110A calculates an aggregated RSRP. In some aspects, the aggregated RSRP may be calculated based on the UEs (e.g., UE 110A, 110B, 110C) in the UECS subset 508. In some other aspects, the aggregated RSRP may be calculated based on all of the UEs in the UECS. In some aspects, the aggregated RSRP may be the maximum RSRP reported by the UEs in the UECS or UECS subset. In some other aspects, the aggregated RSRP may be an average or combination of the RSRPs of the UEs in the UECS or UECS subset. The combination of RSRPs may be a linear combination or a combination in the log domain.

At operations 512A, 512B, and 512C, the coordinating UE 110A transmits the aggregated RSRP to UEs 110B, 110C, and 110D, respectively, via a short-range communications link.

At operation 514, UEs 110A-110D jointly transmit, via an uplink transmission, the aggregated RSRP to the base station 120.

At operation 516, the UEs in the UECS subset 508 (e.g., UEs 110A-110C) jointly receive a downlink signal transmission from the base station 120. In this example, the UECS subset 508 may be referred to as a “joint reception subset.” The downlink signal transmission may be intended for a target UE within the UECS or for the coordinating UE.

At operations 518A and 518B, the UEs in the UECS subset 508 (e.g., UE 110B and 110C) transmit their respective portions of the signal to the coordinating UE 110A.

At operation 520, the coordinating UE 110A may generate the signal data from the portions received from the UEs (e.g., UE 110B and 110C) in the UECS subset 508, along with its own portion of the signal. The coordinating UE 110A may send the generated signal to the target UE of the UECS via the short range communications link (if the target UE is not the coordinating UE 110A).

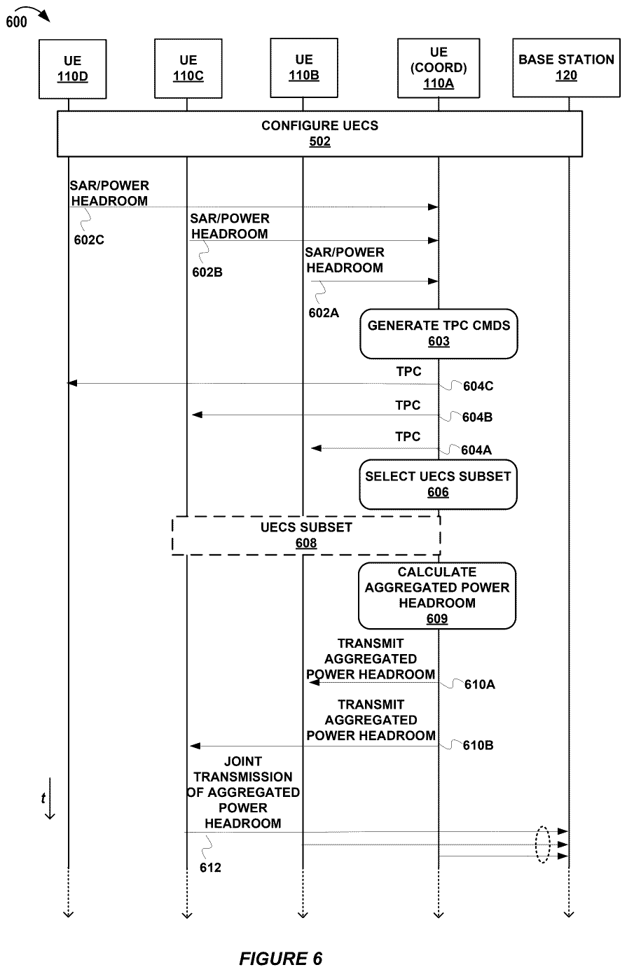

FIG. 6 is a sequence diagram 600 illustrating operations for joint transmission by a joint transmission subset of a UECS. Although not illustrated for the sake of illustration clarity, various acknowledgements for messages illustrated in FIG. 6 may be implemented to ensure reliable operations of UECS control aggregation.

At operation 502 and as described above with respect to FIGS. 4A, 4B, and 5, the base station 120 configures a UECS (e.g., the UECS 117) including the UEs 110A-110D. The base station 120 configures the UE 110A as the coordinating UE for the UECS. Although, for the sake of illustration clarity, the UECS in FIG. 6 is illustrated as including four UEs, any suitable number of UEs may be included in the UECS.

At operations 602A-602C, the UEs in the UECS (e.g., UEs 110B-110D) report either or both their respective SAR constraints and power headroom to the coordinating UE 110A via the short range communications link. In some aspects, a UE may calculate a power headroom as a maximum power as allowed by base station 120 and/or regulatory conditions minus the current UE transmit power specified for joint transmission to the base station 120.

At operation 603, coordinating UE 110A generates transmit power control (TPC) commands for each respective UE of the other UEs in the UECS (e.g., UEs 110B-110D). In some aspects, the coordinating UE 110A generates the TPC commands based on the SAR constraints and/or power headroom of each respect UE. In some aspects, the coordinating UE calculates the TPC commands as part of a closed loop power control algorithm in which the coordination UE calculates a TPC command that instructs the respective UE to increase or decrease the UE's transmission power. In some aspects, the coordinating UE 110A may instruct the UE to increase or decrease the UE's transmission power by an amount necessary to achieve the desired transmission power for the UE. In some aspects, the coordinating UE 110A may instruct the UE to set the UE's transmission power to a specific transmission power. In some aspects, the UE may generate TPC commands and perform closed loop power control with respect to UEs in the UECS (e.g., as defined in 3GPP Technical Specification 38.213). In UE based closed loop power control for a UECS, a coordinating UE (for example, UE 110A) sends power control commands to other UEs in the UECS that instruct the other UEs to adjust their transmit power in order to provide optimal transmission power for signals to a base station. The coordinating UE may use SAR or power headroom information received from the other UEs of the UECS along with signal quality information from the base station (e.g., signal to noise ratio (SNR), signal-to-interference & noise ratio (SINR)) to determine appropriate TPC commands for each of the non-coordinating UEs in the UECS to control their respective transmission powers. Thus, a feedback loop exists in which the coordinating UE calculates a power level needed to maintain appropriate signal quality, and the non-coordinating UEs adjust their respective transmit powers based on feedback from the coordinating UE. The UEs 110B-110D may perform uplink transmissions in accordance with the TPC commands from the coordinating UE 110A (not shown).

At operations 604A-604C, the coordinating UE 110A transmits the TPC commands generated at operation 603 to the respective UEs 110B-110D. In some aspects, the coordinating UE 110A transmits the TPC commands to UEs in the UECS using the short range communications link.

At operation 606, the coordinating UE 110A may select a UECS subset 608 of the UEs in the UECS (e.g., UECS 117). As one example, the coordinating UE 110A may select UEs for inclusion in the UECS subset 608 based on the UE's power headroom. The coordinating UE 110A may select those UEs with a relatively higher power headroom for inclusion in the UECS subset 608 and omit UEs with a relatively lower power headroom from the UECS subset 608. In the example illustrated in FIG. 6, UEs 110B and 110C have relatively higher power headrooms when compared with UE 110D. Thus, in this example, the coordinating UE 110A has selected UE 110B and UE 110C for inclusion in the UECS subset 608 and has omitted UE 110D from the UECS subset 608. The UEs in the UECS subset 608 may be used in later joint transmissions to the base station 120 (e.g., at operation 612 described below). In other examples, the coordinating UE 110A may select UEs for inclusion in the UECS subset 608 based on the SAR constraint along with the power headroom.

At operation 609, the coordinating UE 110A calculates an aggregated power headroom of the UEs in the UECS subset 608. The coordinating UE 110A may calculate the aggregated power headroom in various ways. In some aspects, the coordinating UE 110A may calculate the aggregated power headroom as the minimum power headroom of the power headrooms reported by each UE in the UECS subset 608. In some other aspects, the coordinating UE 110A may calculate the aggregated power headroom as the maximum power headroom of the power headrooms reported by each UE in the UECS subset 608. In still other aspects, the coordinating UE 110A may calculate the aggregated power headroom as the average power headroom of the power headrooms reported by each UE in the UECS subset 608.

At operations 610A and 610B, the coordinating UE 110A transmits the aggregated power headroom to the UEs in the UECS subset 608, UEs 110B and 110C, respectively. In some aspects, the coordinating UE 110A transmits the aggregated power headroom via the short range communications link.

At operation 612, the UEs in the UECS subset 608 (e.g., UEs 110A, 110B, and 110C) perform a joint transmission of the aggregated power headroom calculated at operation 609 to the base station 120.

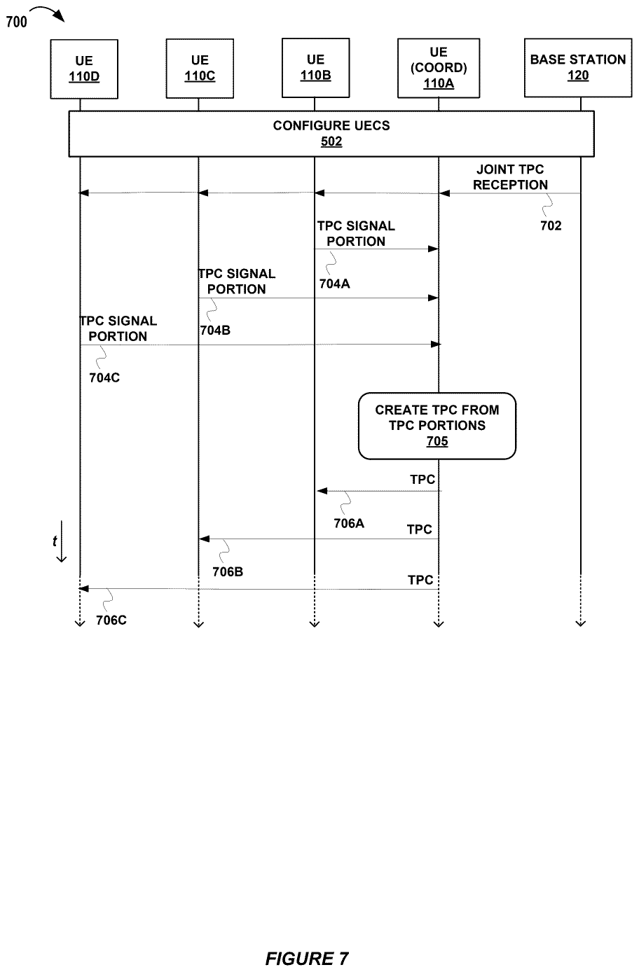

FIG. 7 is a sequence diagram 700 illustrating operations for power control of a joint transmission subset of a UECS. Although not illustrated for the sake of illustration clarity, various acknowledgements for messages illustrated in FIG. 7 may be implemented to ensure reliable operations of UECS control aggregation.

At operation 502 and as described above with respect to FIGS. 4A, 4B, 5, and 6, the base station 120 configures a UECS (e.g., the UECS 117) including the UEs 110A-110D. The base station 120 configures the UE 110A as the coordinating UE for the UECS. Although, for the sake of illustration clarity, the UECS in FIG. 7 is illustrated as including four UEs, any suitable number of UEs may be included in the UECS.

At operation 702, the base station 102 transmits a power control command (e.g., TPC command) for the UECS. The UEs in the UECS jointly receive the power control command. In some aspects, the base station 120 may calculate a value for the power control command that is to apply to the UECS as a whole. In this aspect, the calculation of the value for the power control command may be less complicated for the base station and may have lower overhead on the PDCCH used to transmit the power control command. In some aspects, the base station 120 may calculate a value for individualized power control commands for each UE in the UECS based on each UEs transmissions. In this aspect, link performance may be improved because the power control command may be tailored to each individual UE in the UECS.

At operations 704A-704C, the UEs 110B-110D transmit their respective portions of the power control command received by the respective UE to the coordinating UE 110A. In some aspects, the UEs 110B-110D may transmit their respective portions of the power control command to the coordinating UE 110A via a short range communications link.

At operation 705, the coordinating UE 110A creates individual power control commands (e.g., TPC commands) for each UE in the UECS based on the respective portions received from UEs 110B-110D. In some aspects, coordinating UE 110A may create an individualized power control command based on the power control command received from the base station 120 via joint reception at operation 702. In some aspects, the power control command may be further based on a power constraint, including one or more of a power class of the UE, power headroom reported by the UE, SAR constraints of the UE, battery status of the UE, and/or the UE's RSRP, among other factors.

At operations 706A-706C, the coordinating UE 110A transmits individual power control commands to the other UEs in the UECS (e.g., UEs 706B-706D). In some aspects, the coordinating UE 110A may transmit the individual power control commands to the other UEs via the short range communications link.

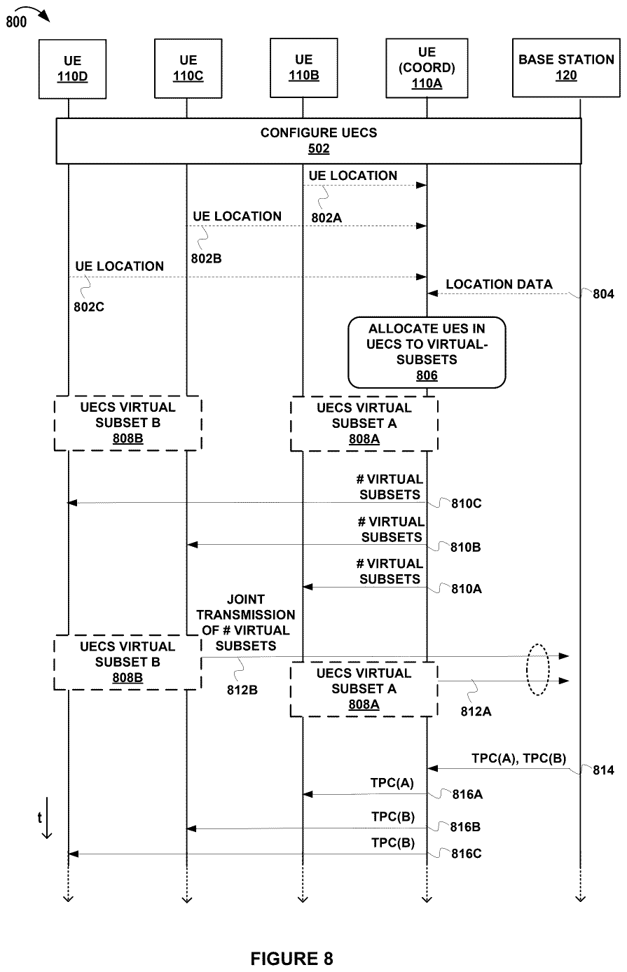

FIG. 8 is a sequence diagram 800 illustrating operations for creating and utilizing multiple subsets of a UECS. Although not illustrated for the sake of illustration clarity, various acknowledgements for messages illustrated in FIG. 8 may be implemented to ensure reliable operations of UECS control aggregation.

At operation 502 and as described above with respect to FIGS. 4A, 4B, 5, 6, and 7, the base station 120 configures a UECS (e.g., the UECS 117) including the UEs 110A-110D. The base station 120 configures the UE 110A as the coordinating UE for the UECS. Although, for the sake of illustration clarity, the UECS in FIG. 8 is illustrated as including four UEs, any suitable number of UEs may be included in the UECS.

In some aspects, the coordinating UE 110A may create multiple subsets of a UECS based on location information associated with UEs in the UECS subset. The location information may be received from the UEs of the UECS or may be received from base station 120. For example, at operations 802A-802C, one or more of UEs 110B-110D may optionally transmit their location (e.g., GPS position) to coordinating UE 110A. In some examples, the one or more UEs 110B-110D may transmit its location via a short range communications link.

Location information received from a UE may, in addition or as an alternative, be based on GPS-reported position of the UE. Further, a GPS-equipped UE may locate and report the positions of other UEs. Additionally or alternatively, at operation 804, the base station 120 may optionally transmit location information for one or more of the UEs in the UECS to the coordinating UE 110A. The location information reported by the base station 120 may be based on observed time difference of arrival (OTDOA) data, angle of arrival (AOA) data, or angle of departure (AOD) data, among other information.

At operation 806, the coordinating UE 110A allocates the UEs in the UECS to virtual subsets. The subsets are “virtual” in the sense that the UEs that are members of the respective virtual subsets are transparent to the base station 120. In the example illustrated in FIG. 8, coordinating UE 110A has allocated itself and UE 110B to a first virtual subset 808A and has allocated UEs 110C and 110D to a second virtual subset 808B. In some aspects, the coordinating UE 110A allocates UEs to a virtual subset based on the location or position of the UE. For example, the coordinating UE 110A may allocate UEs that are near each other to the same virtual subset. This may be desirable, as choosing UEs that are near one another for a virtual subset will likely have a similar path loss to the base station and other similar transmission/reception characteristics with respect to the base station.

At operations 810A-810C, the coordinating UE 110A transmits virtual subset information to the UEs of the UECS that have been selected for inclusion in a virtual subset (e.g., UEs 110B-110D, respectively). For example, the coordinating UE 110A may transmit the number of virtual subsets that the coordinating UE 110A has formed. In some aspects, the coordinating UE 110A may include identification information, transmission parameters, timing information, and the like for the virtual subsets.

At operations 812A and 812B, the UEs selected for inclusion in virtual subset 808A and 808B, respectively, jointly transmit the number of virtual subsets to the base station 120. The base station 120 may be informed of the number of virtual subsets formed by the coordinating UE 110A but is not necessarily informed of the number of UEs in each virtual subset, nor of the identity of UEs in a virtual subset. From the point of view of the base station 120, each virtual subset 808A and 808B behaves like a TX port of the coordinating UE 110A (or source UE). Thus, the coordinating UE 110A may use the virtual subsets as transmit ports in a MIMO transmission. For instance, in the example shown in FIG. 8, virtual subsets 808A and 808B may be used in an uplink (UL) 2×2 MIMO joint transmission.

At operation 814, the base station 120 transmits power control commands (e.g., TPC commands) for each of the virtual subsets to the coordinating UE 110A.

At operation 816A, the coordinating UE 110A forwards the power control command for virtual subset 808A (e.g., TPC(A)) to UEs in the virtual subset A (e.g., UE 110B). At operations 816B and 816C, the coordinating UE 110A forwards the power control command for virtual subset 808B (e.g., TPC(B)) to UEs in the virtual subset B (e.g., UE 110C and 110D).

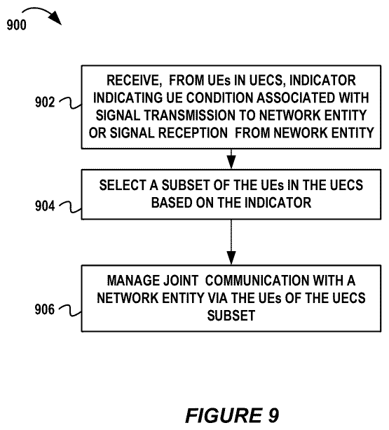

FIG. 9 is a flow chart diagram illustrating example operations of a method 900 for managing joint communication by a coordinating UE of a UECS. The example operations of method 900 may be performed by a coordinating UE, for example, UE 110A of FIGS. 1, 4A, 4B, and 5-8. The example operations illustrated in method 900 may be performed with respect to a UECS that is created as described above with respect to FIG. 4A.

The method 900 begins at block 902 with the coordinating UE receiving, from one or more of the UEs in the UECS, an indicator of a UE condition associated with signal transmission from the UE to a network entity, or signal reception from the network entity to the UE. The network entity may be a base station, or one or more of an RU, DU, and/or CU. In some aspects, the UE condition may be an RSRP associated with the signal reception from the network entity. In some other aspects, the UE condition may be a power headroom associated with the signal transmission to the network entity. In some aspects, the network entity may be a base station. In some aspects, the network entity may be distributed across an RU, DU, and/or CU. In some aspects, the UE condition may be a SAR constraint, battery condition, thermal condition, power headroom, geographic location, power class, among others.

At block 904, and as discussed above at FIG. 4B, FIG. 5, operation 506, FIG. 6, operation 606, and FIG. 8, operation 806, the coordinating UE may select a subset (or subsets) of the UECS based on the indicator of the UE condition.

At block 906, and as discussed above with respect to FIGS. 4A, 4B, and 5-8, the coordinating UE may manage a joint communication with the network entity via the selected UECS subset(s). The coordinating UE may manage various aspects of a joint communications between UEs in the UECS and the network entity. For example, the coordinating UE may configure the UEs in the UECS subset for joint reception of data from the network entity. As another example, the coordinating UE may configure the UEs in the UECS for joint transmission of data to the network entity.

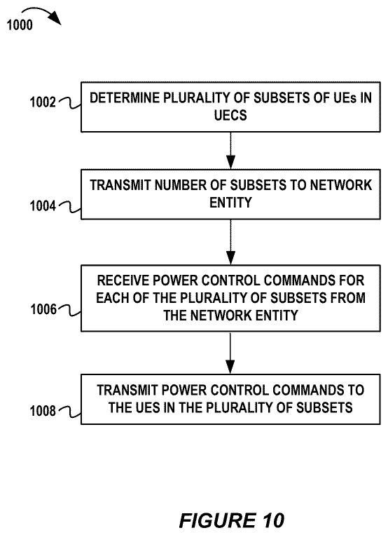

FIG. 10 is a flow chart diagram illustrating operations of a method 1000 for power control of multiple subsets (e.g., virtual subsets) of UEs of a UECS. The example operations of method 1000 may be performed by a coordinating UE, for example, UE 110A of FIGS. 1, 4A, 4B, and 5-8. The example operations illustrated in method 1000 may be performed by a coordinating UE with respect to a UECS that is created as described above with respect to FIG. 4A.

The method 1000 begins at block 1002, where, as described above with respect to FIG. 4B and FIG. 8, operations 802-806, the coordinating UE determines a plurality of subsets of the UECS, referred to as UECS subsets. In some aspects, the coordinating UE may select UEs for inclusion in a UECS subset based on the location of UEs in the UECS. For example, the coordinating UE may select UEs of the UECS that are near one another for inclusion in the same UECS subset. The coordinating UE may receive the locations of UEs in the UECS from the UEs themselves, or the location may be received from the network entity, or both the UEs and the network entity.

At block 1004, and as discussed above with respect to FIG. 4B and FIG. 8, operations 812A and 812B, the coordinating UE may transmit, to a network entity, information about each of the multiple UECS subsets created by the coordinating UECS. The coordinating UE may initiate a joint transmission of the information about the multiple UECS subsets to the network entity such that each UE of the UECS transmits the signal carrying the information to the network entity. In some aspects, the information includes the number of UECS subsets created by the coordinating UE. Each of the UECS subsets may behave like a transmit port of the coordinating UE (or a source UE).

At block 1006 and as described above at FIG. 8, operation 814, the coordinating UE receives, from the network entity, power control commands for the each of the multiple UECS subsets. In some aspects, the network entity provides a single power control command that is to be applied to each of the multiple UECS subsets. In some aspects, the network entity provides a separate power control command for each UECS subset.

At block 1008, and as described above at FIG. 8, operations 816A-816C, the coordinating UE transmits the power control commands to the UEs in the UE subsets. For example, the coordinating UE may transmit a power control command received from the network entity for a first UECS subset to the UEs in the first UECS subset, transmit a power control command received from the network entity for a second UECS subset to the UEs in the second UECS subset, and so forth.

Some or all of the operations described above with respect to the methods 900 and 1000 in FIGS. 9 and 10, respectively, may be repeated for the duration of a communications session between the UEs and a base station as the UE conditions change. For example, the UEs in a UECS may change location relative to one another and to the coordinating UE, battery conditions of a UE in a UECS subset may change, thermal conditions of a UE in a UECS may change etc. The coordinating UE may receive updated information about the changed condition of one or more UEs in a UECS and may modify or recreate a UECS subset to include different UEs from the previous UECS subset based on the updated condition information.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes.

As used herein, the terms “component” and “module” are intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations, and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with processing circuitry, examples of which include a general purpose single-or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations, and methods may be performed by circuitry that is specific to a given function.

As described above, in some aspects implementations of the subject matter described in this specification can be implemented as software. For example, various functions of components disclosed herein, or various blocks or steps of a method, operation, process, or algorithm disclosed herein can be implemented as one or more modules of one or more computer programs. Such computer programs can include non-transitory processor-or computer-executable instructions encoded on one or more tangible processor-or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

As used herein, the terms “user equipment”, “wireless communication device”, “mobile communication device”, “communication device”, or “mobile device” refer to any one or all of cellular telephones, smartphones, portable computing devices, personal or mobile multimedia players, laptop computers, tablet computers, smartbooks, Internet-of-Things (IoT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers or routers, and similar electronic devices which include a processing circuitry such as a programmable processor, memory, and other circuitry configured to perform operations as described herein.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations and should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method for wireless communication by a coordinating user equipment (UE) of a user equipment coordination set (UECS), comprising:
receiving, from one or more UEs of the UECS, an indicator corresponding to each of the one or more UEs, the indicator indicating a UE condition associated with at least one of a signal transmission to a network entity or a signal reception from the network entity;
selecting a subset of the one or more UEs for inclusion in a UECS subset based on the UE condition of each corresponding UE of the UECS; and
managing a joint communication with the network entity via the UECS subset.

2. The method of claim 1, wherein the indicator comprises a reference signal received power (RSRP), and wherein the method further comprises:
calculating an aggregated RSRP based on the RSRP of each UE of the UECS;
transmitting the aggregated RSRP to the one or more UEs of the UECS; and
jointly transmitting, with the one or more UEs of the UECS, the aggregated RSRP to the network entity.

3. The method of claim 2, wherein calculating the aggregated RSRP comprises at least one of:
calculating a maximum RSRP of the one or more UEs of the UECS;
calculating an average RSRP of the one or more UEs of the UECS; or
calculating a linear combination of the RSRP of each UE of the one or more UEs of the UECS.

4. The method of claim 2, wherein managing the joint communication comprises configuring each UE of the UECS subset for joint reception with the network entity.

5. The method of claim 2, wherein transmitting the aggregated RSRP comprises transmitting the aggregated RSRP via a first short-range communications link.

6. The method of claim 1, wherein the UE condition comprises a power headroom, and wherein the method further comprises:
transmitting a power control command to each UE of the UECS subset; and
initiating, based on the power control command transmitted to each UE of the UECS subset, a joint transmission to the network entity.

7. The method of claim 1,
wherein the UECS subset comprises a joint transmission subset determined by the coordinating UE based on a corresponding power headroom of each UE of the UECS,
wherein the method further comprises:
receiving, from a source UE of the UECS, data; and
transmitting, to each UE of the joint transmission subset, a corresponding portion the data,
wherein managing the joint communication comprises initiating a joint transmission, by each UE of the joint transmission subset, the corresponding portion of the data to the network entity.

8. The method of claim 7, further comprising:
calculating an aggregated power headroom based on the corresponding power headroom of each UE of the joint transmission subset;
calculating the aggregated power headroom comprises calculating a minimum power headroom or a maximum power headroom of the UEs of the joint transmission subset;
transmitting the aggregated power headroom to each UE of the joint transmission subset; and
initiating joint transmission of the aggregated power headroom by each UE of the joint transmission subset to the network entity.

9. (canceled)

10. The method of claim 1, further comprising:
receiving, from each UE of the UECS subset, a corresponding portion of a first power control command for the UECS;
generating the first power control command based on each corresponding portion of the first power control command; and
transmitting, to each UE of the UECS, a corresponding second power control command based on the first power control command and a corresponding power constraint of each UE of the UECS.

11. The method of claim 10, wherein the corresponding power constraint comprises at least one of a power class of the UE, a power headroom of the UE, a specific absorption rate (SAR) constraint of the UE, a battery status of the UE, or a RSRP of the UE.

12. The method of claim 1, wherein the selecting the subset comprises selecting a first subset of the one or more UEs of the UECS for inclusion in a first UECS subset and a second subset of the one or more UEs of the UECS for inclusion in a second UECS subset, and wherein the method further comprises:
transmitting to the network entity, information that indicates the first UECS subset and the second UECS subset;
receiving, from the network entity, a first power control command for the first UECS subset and a second power control command for the second UECS subset;
transmitting a third power control command to each UE of the first UECS subset based on the first power control command; and
transmitting a fourth power control command to each UE of the second UECS subset based on the second power control command.

13. The method of claim 12, further comprising:
receiving a location of each of the one or more UEs of the UECS,
wherein selecting the first UECS subset and the second UECS subset comprises selecting the first UECS subset and the second UECS subset based on the location corresponding to each of the one or more UEs.

14. The method of claim 13, wherein receiving the location of each of the one or more UEs of the UECS includes at least one of:
receiving, from each UE of the one or more of UEs of the UECS, a corresponding global positioning system (GPS) location of the UE;
receiving the location of each of the one or more UEs from the network entity; or receiving at least one of observed time difference of arrival (OTDOA) data, angle of arrival (AOA) data, or angle of departure (AOD) data for each of the one or more UEs.

15-16. (canceled)

17. The method of claim 12, wherein each of the first UECS subset and the second UECS subset functions as a transmit port of any UE of the UECS.

18. A User Equipment (UE), comprising:
a communication unit; and
a processing system configured to control the communication unit to:
receive, from one or more UEs of a user equipment coordination set (UECS), an indicator corresponding to each of the one or more UEs, the indicator indicating a UE condition associated with at least one of a signal transmission to a network entity or a signal reception from the network entity;
select a subset of the one or more UEs for inclusion in a UECS subset based on the UE condition of each corresponding UE of the UECS; and
manage a joint communication with the network entity via the UECS subset.

19. The UE of claim 18, wherein the processing system is configured to control the communication unit to:
calculate an aggregated RSRP based on the RSRP of each UE of the UECS;
transmit the aggregated RSRP to the one or more UEs of the UECS; and
jointly transmit, with the one or more UEs of the UECS, the aggregated RSRP to the network entity.

20. The UE of claim 18, wherein the processing system is configured to control the communication unit to:
calculate a maximum RSRP of the one or more UEs of the UECS;
calculate an average RSRP of the one or more UEs of the UECS; or
calculate a linear combination of the RSRP of each UE of the one or more UEs of the UECS.

21. The UE of claim 18, wherein the processing system is configured to control the communication unit to:
transmit a power control command to each UE of the UECS subset; and
initiate, based on the power control command transmitted to each UE of the UECS subset, a joint transmission to the network entity.

22. The UE of claim 18, wherein the processing system is configured to control the communication unit to:
receive, from each UE of the UECS subset, a corresponding portion of a first power control command for the UECS;
generate the first power control command based on each corresponding portion of the first power control command; and
transmit, to each UE of the UECS, a corresponding second power control command based on the first power control command and a corresponding power constraint of each UE of the UECS.

23. The UE of claim 18, wherein the processing system is configured to control the communication unit to:
receive a location of each of the one or more UEs of the UECS by at least one of:
receive, from each UE of the one or more of UEs of the UECS, a corresponding global positioning system (GPS) location of the UE;
receive the location of each of the one or more UEs of the UECS from the network entity; or
receive at least one of observed time difference of arrival (OTDOA) data, angle of arrival (AOA) data, or angle of departure (AOD) data for each UE of the one or more UEs of the UECS; and
wherein to select the subset, the communication unit is configured to select a first subset of the one or more UEs of the UECS for inclusion in a first UECS subset and a second subset of the one or more UEs of the UECS for inclusion in a second UECS based on the location corresponding to each of the one or more UEs of the UECS.
